(19) United States
(12) Patent Application Publication
(10) Pub. No.: US 2012/0260489 A1
(43) Pub. Date: Oct. 18, 2012

(54) BUTTON REPAIR SYSTEM AND METHOD

(76) Inventor: Elaine T. Hamilton, Kansas City, MO (US)

(21) Appl. No.: 13/450,248

(22) Filed: Apr. 18, 2012

Related U.S. Application Data
(60) Provisional application No. 61/476,640, filed on Apr. 18, 2011.

(51) Int. Cl. A41F 1/00; B23P 11/00

(52) U.S. Cl. 29/525.03; 24/596.1

(57) ABSTRACT

A button replacement and reinforcement system which provides a quick and simple alternative to sewing a button into place. This system is versatile in that it can be used on buttons with one or up to four holes. It provides a secure attachment or reinforcement to button placement, and is also able to add buttons as an embellishment to a variety of materials, including materials. It is quick and simple to use, and hold buttons securely in place without the need for a needle or thread.

### CROSS-REFERENCE TO RELATED APPLICATION

This application claims priority in U.S. Provisional Patent Application No. 61/476,640, filed Apr. 18, 2011, which is incorporated herein by reference.

### BACKGROUND OF THE INVENTION

1. Field of the Invention

The present invention relates generally to the field of button replacement and reinforcement, and more specifically to a thread-less system and method for replacing a button on a piece of material.

2. Description of Related Art

The present system solves a long-desired need for a quick alternative to button repair and replacement other than the tedious process of using a needle and thread. Its intended uses are to instantly reconnect missing buttons and support existing buttons that are loose. It may also be used to add buttons where there were none before, and for the addition of buttons for ornamental decoration.

Often buttons become loose, or fall off at times when a traditional repair of using needle and thread is inconvenient. The present invention provides a quick and easy solution to button repair and replacement, as well as adding buttons as a decorative embellishment.

Heretofore there has not been available a single-use applicator with the features and elements of the present invention.

### 1. Description of the Related Art

### BRIEF SUMMARY OF THE INVENTION

In the practice of the present invention, included are the functions of a “button repair system”, a system that not only securely replaces, but creates a secure support for loose buttons. This system also creates a secure way to embellish and decorate material with buttons.

This system can be used on many types of material and is versatile enough to be inserted through buttons with one or up to four holes.

The materials used to design this system will include, but not be limited to casting resin, plastic, or metal with safety features designed to protect the user from getting stuck by the sharp ends while giving it the ability to go through varied, even thick material easily. The notches fasten for user protection.

### BRIEF DESCRIPTION OF THE DRAWINGS

FIG. 1 is an isometric view of a button repair system, showing how the top portion would pass through a button and connect with the bottom portion.

FIG. 2 is an isometric view of a button repair system, wherein the top and bottom portions have joined through a button.

FIG. 3 is a front elevational view of a button repair system, showing in detail the connection between the top and bottom portions thereof.

FIG. 4 is an isometric view of a button repair system showing a connection with an alternative button type.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

An embodiment of the present invention is generally designed to provide a semi-permanent solution to attaching a button 8 to material 9, such as an article of clothing, without the use of needle and thread.

### II. Threadless Button Replacement System 2

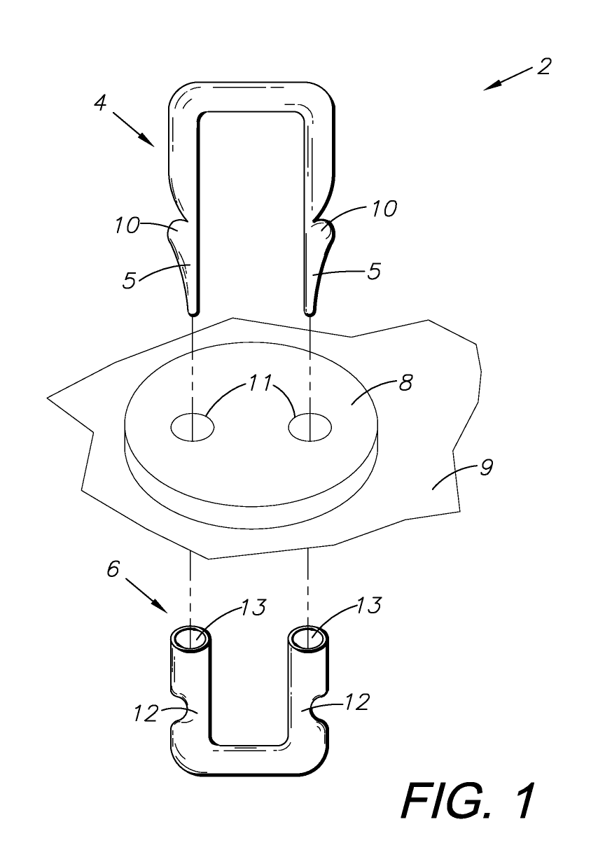

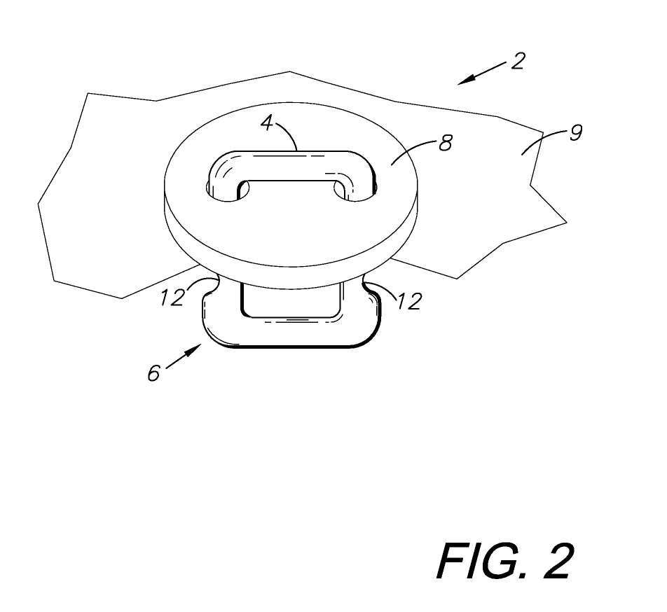

Referring now to the invention in more detail, FIGS. 1 and 2 demonstrate an exemplary button replacement system 2. It includes a top fastener portion 4 and a bottom clamp or receiver portion 6. Both the fastener 4 and the receiver 6 generally form a “U” shape. A button 8 containing at least two button holes 11 is placed against a piece of material 9. The fastener portion 4 is placed above the button 8, and the receiver portion 6 is placed on the back side of the material.

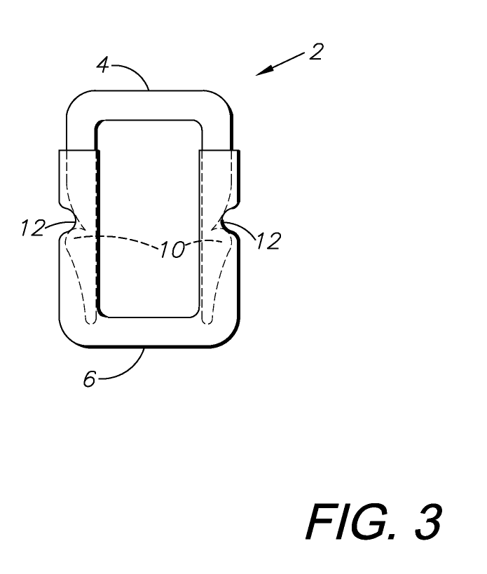

The fastener portion 4 includes a pair of barbs 5 which include a protrusion 10. These barbs are capable of penetrating the material 9 and entering the receiving holes 13 of the receiver portion 6. The receiver portion 6 further includes a clamp indention 12 which acts to receive the barb protrusion 10 of the fastener portion and lock the fastener in place, as shown in more detail in FIG. 3. Although sufficient force may be able to separate this connection, it should be solid enough to form a semi-permanent connection between the fastener 4 and the receiver 6.

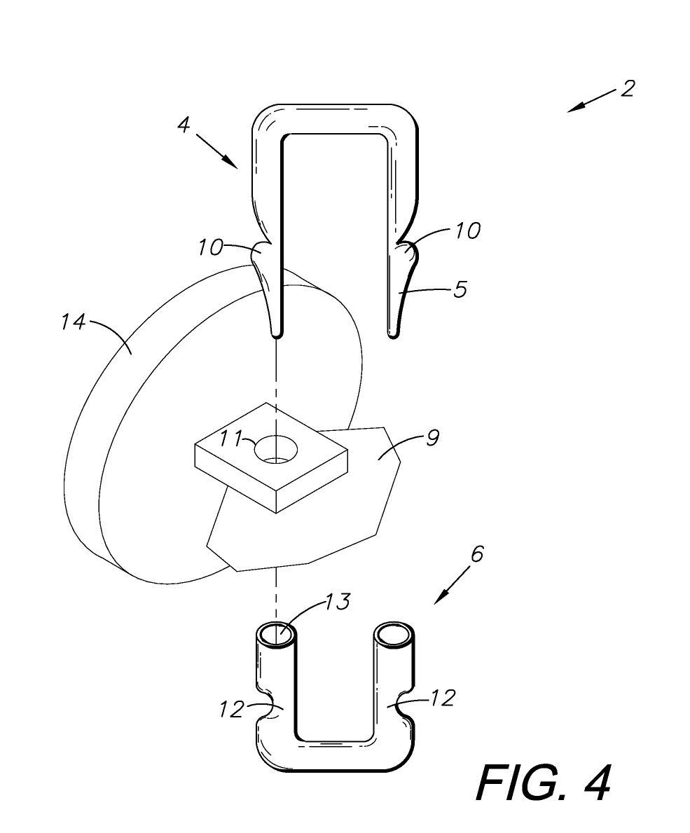

As shown in FIG. 4, the fastener 4 and receiver 6 can be used on buttons with only one hole 11 at the back of the button 14. The Fastener 4 is inserted through the button hole 11 or loop at the back of the button 14, is then inserted through the material 9, and finally locks into the receiver 6.

It is to be understood that the invention can be embodied in various forms, and is not to be limited to the examples discussed above. The range of components and configurations which can be utilized in the practice of the present invention is virtually unlimited.

1. A system for replacing a button on a piece of material comprising:
a fastener comprising a fastener crosspiece including a proximal end and a distal end, a first fastener leg piece joined to said crosspiece proximal end, and a second fastener leg piece joined to said crosspiece distal end;
a receiver comprising a receiver crosspiece including a proximal end and a distal end, a first receiver leg piece joined to said crosspiece proximal end, and a second receiver leg piece joined to said crosspiece distal end;
said first and second fastener leg pieces each further including a barbed end including a protrusion, said barbed end adapted for piercing said material;
said first and second receiver leg pieces each further including a receiver opening and a locking indention;
wherein said first fastener leg piece barbed end is capable of being received by said first receiver leg piece receiver opening, and said second fastener leg piece barbed end is capable of being received by said second receiver leg piece receiver opening; and
wherein said barbed end protrusions are locked in place by said locking indentions, thereby locking said fastener within said receiver.

2. The system of claim 1, further comprising:
said first and second fastener leg pieces forming perpendicular angles with said fastener crosspiece, generally creating a “U” shape; and
said first and second receiver leg pieces forming perpendicular angles with said receiver crosspiece, generally creating a “U” shape.

3. A method for replacing a button on a piece of material comprising the steps:
providing a button with at least one button hole and a piece of material to which said button is to be attached;
providing a button fastening system comprising a fastener portion and a receiver portion, wherein said fastener portion includes two barbed legs and said receiver portion includes two hollow legs capable of receiving and locking said fastener barbed legs;
placing said button in position against said material;
pushing at least one of said barbed legs through said at least one button hole;
further pushing said barbed legs through said material;
inserting said barbed legs into said hollow legs of said receiver portion; and
locking said barbed legs within said hollow legs, thereby affixing said button to said material.

4. The method of claim 3, further comprising the steps:
wherein said button has at least two button holes; and
pushing each of said barbed legs through only one of said at least two button holes.

5. The method of claim 3, wherein:
said barbed legs include a protruding element;
said hollow legs include an indention element; and
wherein said indention element is capable of locking said protruding element in place.
